(19) United States
(12) Patent Application Publication
(10) Pub. No.: US 2008/0116797 A1
(43) Pub. Date: May 22, 2008

(54) PLASMA DISPLAY PANEL

(76) Inventors: Chong-Gi Hong, Yongin-si (KR); Tae-Kyoung Kang, Yongin-si (KR)

Correspondence Address: CHRISTIE, PARKER & HALE, LLP, PO BOX 7068, PASADENA, CA, 91109-7068, US

(21) Appl. No.: 11/842,689

(22) Filed: Aug. 21, 2007

(30) Foreign Application Priority Data
Nov. 17, 2006 (KR) 10-2006-0114084

(51) Int. Cl. H01J 17/49

(52) U.S. Cl. 313/582

(57) ABSTRACT

A plasma display panel is provided having a front substrate, a rear substrate facing the front substrate, and barrier ribs arranged on the rear substrate to form discharge cells. The plasma display panel further includes first electrodes and second electrodes on the front substrate facing each other in the discharge cells. In addition, a connection bar connects end portions of the first electrodes. Terminals extend from the connection bar. The barrier ribs are arranged only in a display area for displaying an image. Absent the barrier ribs, a space is located in a non-display area in which the connection bar is located.

### CROSS-REFERENCE TO RELATED APPLICATION

This application claims priority to and the benefit of Korean Patent Application No. 10-2006-0114084 filed in the Korean Intellectual Property Office on Nov. 17, 2006, the entire content of which is incorporated herein by reference.

### BACKGROUND OF THE INVENTION

1. Field of the Invention

The present invention relates to a plasma display panel having an improved image display capability.

2. Description of the Related Art

A plasma display panel (PDP) is a display device in which an image is formed by using visible light generated when ultraviolet rays, which are emitted from plasma produced by a gas discharge, excite a phosphor layer. Due to their large screen size with high resolution, PDPs are highly anticipated as the next generation flat panel display devices.

In general, the PDP has a three-electrode surface discharge type structure in which a pair of electrodes are formed on a front substrate, and address electrodes are provided on a rear substrate spaced apart from the front substrate. The electrodes respectively correspond to discharge cells.

Millions of unit discharge cells may be arranged inside the PDP in a matrix form. By using a memory characteristic of wall charges, particular discharge cells are selected for turning on to display an image.

In order to control the PDP, each electrode has terminals formed at end portions of the substrates. The terminals are connected to a driving board so as to supply driving voltages required for the electrodes.

Because the PDP is driven at a high voltage, heat generation in the terminals where the electrodes are present has been a problem. The problem is severe at a terminal of a sustain electrode constituting a common electrode and is even more severe in an aging process for stabilizing a state of a discharge cell after the PDP is manufactured. In the aging process, the PDP is continuously driven for a long period of time at a voltage higher than the driving voltage.

When the terminals or the substrate are exposed to high heat for a long period of time, damage may occur in a terminal or in the substrate itself.

### SUMMARY OF THE INVENTION

In order to solve the aforementioned problems, exemplary embodiments of the present invention protect a terminal against heat.

According to an embodiment of the present invention, a plasma display panel is provided having a front substrate; a rear substrate facing the front substrate; and barrier ribs arranged on the rear substrate to form discharge cells between the front substrate and the rear substrate. The plasma display panel further includes first electrodes and second electrodes on the front substrate facing each other in the discharge cells. A connection bar connects end portions of the first electrodes. Terminals extend from the connection bar. The barrier ribs are arranged only in a display area for displaying an image, and absent the barrier ribs, a space is located in a non-display area in which the connection bar is located.

In the aforementioned embodiment of the present invention, a dielectric layer may cover the first electrodes, the second electrodes, and the connection bar across the display area and the non-display area. Alternatively, the dielectric layer may cover the first electrodes and the second electrodes in the display area only.

According to another embodiment of the present invention, a plasma display panel is provided having a front substrate; a rear substrate facing the front substrate; and barrier ribs arranged on the rear substrate to form discharge cells between the front substrate and the rear substrate. The plasma display panel further includes first electrodes and second electrodes formed on the front substrate facing each other in the discharge cells. A connection bar connects end portions of the first electrodes. Terminals extend from the connection bar. The barrier ribs are arranged only in a display area for displaying an image, and dummy barrier ribs are arranged to form channels in a non-display area adjacent the connection bar.

In the aforementioned embodiment of the present invention, the connection bar may be located above the channels. Furthermore, the dummy barrier ribs may have the same height as the barrier ribs.

According to another embodiment of the present invention, a plasma display panel is provided having a front substrate; a rear substrate facing the front substrate; and barrier ribs arranged on the rear substrate to form discharge cells between the front substrate and the rear substrate. The plasma display panel further includes first electrodes and second electrodes on the front substrate facing each other in the discharge cells. A connection bar connects end portions of the first electrodes. Terminals extend from the connection bar. The barrier ribs are arranged only in a display area for displaying an image, and dummy barrier ribs are arranged in a non-display area where the connection bar is located. The dummy barrier ribs have a height less than a height of the barrier ribs such that a space is formed between the front substrate and the rear substrate.

### BRIEF DESCRIPTION OF THE DRAWINGS

FIG. 1 is a schematic plan view of a plasma display panel constructed according to an embodiment of the present invention.

FIG. 2 is an exploded perspective view showing a structure of a portion A of FIG. 1.

FIG. 3 is a partial enlarged plan view of a terminal of a sustain electrode.

FIG. 4 is a cross-sectional view taken along line IV-IV of FIG. 3.

FIG. 5 is a cross-sectional view showing a dielectric layer formed only in a display area.

FIG. 6 is a plan view showing a stripe-type dummy barrier rib formed in a non-display area.

FIG. 7 is a cross-sectional view taken along line VII-VII of FIG. 6.

FIG. 8 is a plan view showing a closed-type dummy barrier rib formed in a non-display area.

FIG. 9 is a cross-sectional view taken along line IX-IX of FIG. 8.

### DETAILED DESCRIPTION

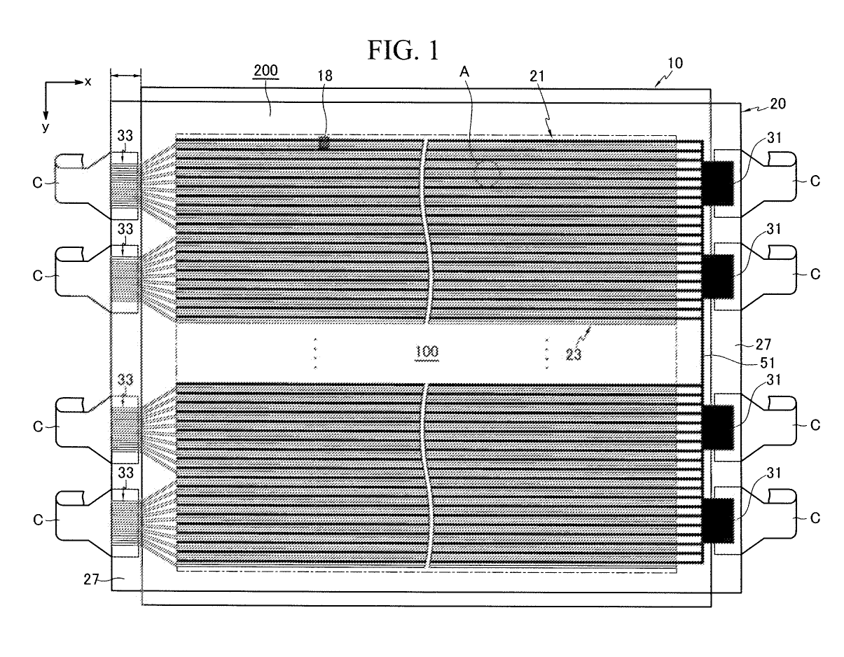

FIG. 1 is a schematic plan view of a plasma display panel (hereinafter, referred to as a PDP) constructed according to an embodiment of the present invention.

Referring to FIG. 1, the PDP according to the present embodiment includes a front substrate 20 and a rear substrate 10 that are sealed with each other while facing each other, for example, with a predetermined gap. The space between the substrates 20, 10 is provided with a plurality of discharge cells 18 defined by barrier ribs so as to generate a plasma discharge.

The discharge cells 18 constitute a display area 100. The PDP is divided into the display area 100 and a non-display area 200. The display area 100 is an area where the plasma discharge occurs among the discharge cells 18, thereby actually displaying an image. The non-display area 200 located at the edges of the display area 100 is an area where the image is not displayed.

Along the discharge cells 18, first electrodes 23 (hereinafter, referred to scan electrodes) and second electrodes 21 (hereinafter, referred to as sustain electrodes) are formed in one direction (x-axis direction in the drawing) on a surface where the front substrate 20 faces the rear substrate 10.

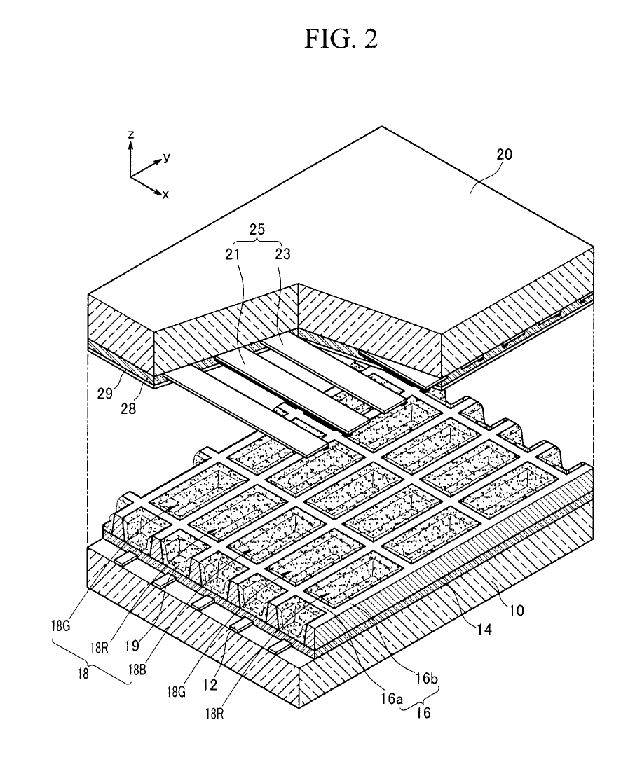

The structure of the discharge cells 18 will now be described in detail with reference to FIG. 2. FIG. 2 is an exploded perspective view showing a portion A of FIG. 1. The sustain electrodes 21 and the scan electrodes 23 form display electrodes 25. Address electrodes 12 are formed on a surface where the rear substrate 10 faces the front substrate 20, wherein the address electrodes 12 cross the display electrodes 25 and the discharges cells 18. In the PDP of the present embodiment, a front substrate 20 and a rear substrate 10 face each other. Further, a space between the substrates 20, 10 is provided with discharge cells 18 defined by barrier ribs 16. The discharge cells 18 constitute a sub-pixel that is a minimum unit for displaying an image. A plurality of sub-pixels constitute one pixel.

Display electrodes 25 and address electrodes 12 are formed in correspondence with respective discharge cells 18. The display electrodes 25 and the address electrodes 12 are spaced apart from each other, and extend in directions such that the two electrodes 25, 12 cross each other. The discharge cells 18 are respectively located at points where the display electrodes 25 cross the address electrodes 12.

The display electrodes 25 are formed on the front substrate 20. The scan electrodes 23 and the sustain electrodes 21 face the discharge cells 18, thereby forming a discharge gap.

The display electrodes 25 are buried with and protected by a dielectric layer 28 formed of a dielectric material (e.g., PbO, B₂O₃, or SiO₂). The dielectric layer 28 protects the display electrodes 25 against damage caused by collision of charge particles during a discharge. The dielectric layer 28 may be covered with a passivation layer 29 (e.g., MgO).

The address electrodes 12 may be formed on the rear substrate 10 facing the front substrate 20. As illustrated in the drawing, the address electrodes 12 cross the display electrodes 25, and extend in one direction (y-axis direction in the drawing) in correspondence with the discharge cells 18. Further, the address electrodes 12 are formed parallel to neighboring address electrodes 12.

The address electrodes 12 are protected while being buried with a dielectric layer 14. The barrier ribs 16 are formed above the address electrodes 12 so as to define the discharge cells 18, wherein each barrier rib 16 includes a first barrier member 16a extending in the x-axis direction in the drawing and a second barrier member 16b extending in the y-axis direction in the drawing.

Phosphor layers 19 emitting visible light of respective colors are formed inside the discharge cells 18. In order to display an image, the phosphor layers 19 are formed in the discharge cells 18 for red R, green G, and blue B colors. A red discharge cell 18R, a green discharge cell 18G, and a blue discharge cell 18B as one group constitute one pixel.

The insides of the discharge cells 18 formed with the phosphor layers 19 are filled with a mixture gas, such as neon and xenon.

According to the aforementioned structure, the discharge cells 18 are formed on the display area 100, thereby displaying an image.

Referring back to FIG. 1, the scan electrodes 23 and the sustain electrodes 21, which face each other in the discharge cells 18, respectively extend in one direction (x-axis direction in the drawing). Thus, terminals 31, 33 are respectively formed at each end of the front substrate 20. The rear substrate 10 is sealed with the front substrate 20 in a crossed manner such that exposure areas 27 are formed at both ends of the front substrate 20. The exposure areas 27 belong to the non-display area 200 of the PDP. The scan electrodes 23 and the sustain electrodes 21 formed along the discharge cells 18 of the display area 100 respectively form the terminals 31, 33 in the exposure areas 27.

The terminals 31, 33 are connected to a circuit board (not shown) that allows the sustain electrodes 21 and the scan electrodes 23, respectively, to generate electrical driving signals. In the drawing, the scan electrodes 23 extend from the terminals 33 in a positive x-axis direction, whereas the sustain electrodes extend from the terminals 31 in a negative x-axis direction.

The terminals 31, 33 formed as described above are connected to the driving board while being electrically in contact with a flexible signal line C (e.g., FPC, TCP). Accordingly, a driving voltage for controlling a charge state for each discharge cell is supplied to the scan electrodes 23 and the sustain electrodes 21, thereby generating a discharge.

The scan electrodes 23 select the discharge cells 18 that are turned on according to an interaction with the address electrodes 12. The sustain electrodes 21 generate a discharge in the discharge cells 18 selected as described above. Thus, a driving voltage for selecting the discharge cells 18 is selectively supplied to the scan electrodes 23 by distinguishing the scan electrodes 23. However, the driving voltage is supplied to all of the sustain electrodes 21 without having to distinguish the sustain electrodes 21.

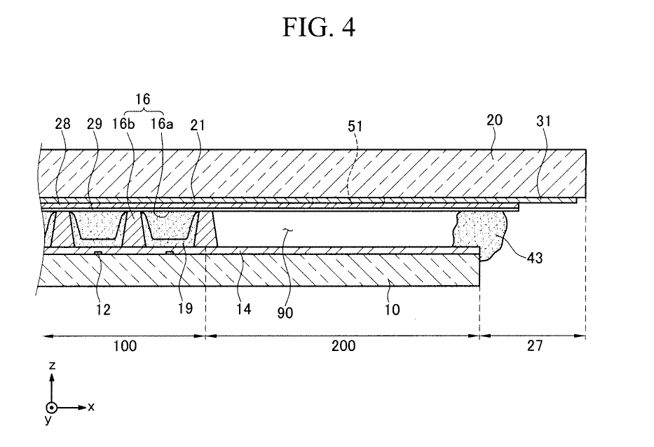

As shown in the drawing, the terminals 31, 33 of the sustain electrodes 21 and the scan electrodes 23, respectively, form electrode groups including a plurality of scan electrodes 23 or a plurality of sustain electrodes 21. End portions of the electrode groups are disposed in one of the exposure areas 27, thereby forming the terminals 31, 33. The edges of the front substrate 20 and rear substrate 10 are sealed with a sealant 43 (shown in FIG. 4).

End portions of the sustain electrodes 21 are electrically connected through a connection bar 51 in the non-display area 200. The terminals 31 extend from the connection bar 51 so as to be formed in one of the exposure areas 27. In the present embodiment, as described above, the connection bar 51 is formed at the end portions of the sustain electrodes 21, thereby protecting the terminals 31 against heat concentration.

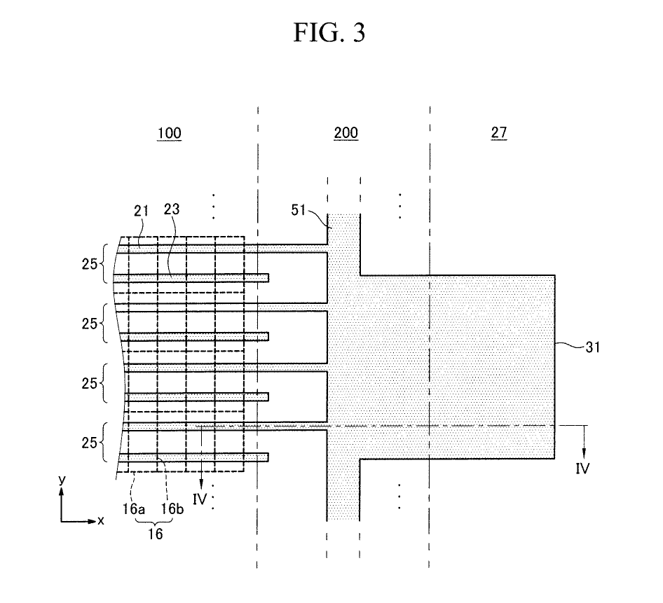

In addition, according to the present embodiment, the barrier ribs 16 are formed only in the display area 100, such that heat generated from the connection bar 51 formed in the non-display area 200 can be easily dissipated. This will be described in detail with reference to FIG. 3, which is a plan view illustrating a layout relation between end portions of the sustain electrodes 21 and the barrier ribs 16.

Referring to FIG. 3, the sustain electrodes 21 extend from the display area 100 to the non-display area 200 in the x-axis direction in the drawing. End portions of the sustain electrodes 21 are connected to one another in the non-display area 200 through the connection bar 51. The connection bar 51 is formed extending in the y-axis direction in the drawing.

The connection bar 51 connects the sustain electrodes 21 so as to supply a common driving voltage to the respective sustain electrodes 21. Further, when heat generated from the terminals 31 is conducted, the connection bar 51 prevents the heat from being concentrated at the terminals 31.

The barrier ribs 16 are formed only in the display area 100. Hence, the barrier ribs 16 are not present in the non-display area 200, thereby forming an empty space 90 (FIG. 4). The connection bar 51 is formed in a portion facing the empty space 90.

This will be described in detail with reference to FIG. 4. Referring to FIG. 4, the sustain electrodes 21 are formed as a thin film in the display area 100 on the front substrate 20, and extend towards an end portion of the front substrate 20.

The sustain electrodes 21 are connected to the connection bar 51. With the terminals 31 connected to the connection bar 51, the sustain electrodes 21 extend to the end portion of the front substrate 20.

Similarly to the sustain electrodes 21, the connection bar 51 and the terminals 31 are formed as a thin film on the front substrate 20.

A dielectric layer 28 is formed on the sustain electrodes 21 having a particular thickness (e.g., a predetermined thickness). The dielectric layer 28 covers the connection bar 51 except for the terminals 31.

The barrier ribs 16 are located at a space between the front substrate 20 and the rear substrate 10, thereby defining the discharge cells 18. The barrier ribs 16 are formed on the rear substrate 10 at a portion facing the sustain electrodes 21. Accordingly, a display area 100 is defined.

Each barrier rib 16 includes a first barrier member 16a defining a discharge cell in the x-axis direction in the drawing and a second barrier member 16b defining a discharge cell in the y-axis direction in the drawing, thereby defining a space between the front substrate 20 and the rear substrate 10. Accordingly, the discharge cells 18 are defined as closed type in which the x-axis direction and the y-axis direction in the drawing are closed.

The space between the front substrate 20 and the rear substrate 10 is closed where the barrier ribs 16 are formed. However, a place where the barrier ribs 16 are not formed remains as the empty space 90.

The connection bar 51 is located on the front substrate 20 in correspondence with the empty space 90.

Thus, even if heat generated from the terminals 31 is conducted to the connection bar 51, because the connection bar 51 faces the empty space 90, the heat conducted to the connection bar 51 is transferred to the empty space 90, thereby cooling off the terminals 31.

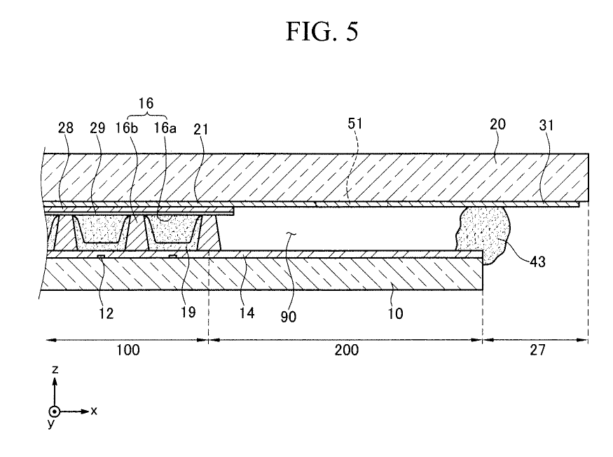

In order to facilitate heat transfer from the connection bar 51 to the empty space 90, the dielectric layer 28 may selectively cover only the sustain electrodes 21 (see FIG. 5). In this case, the dielectric layer 28 is formed only in a portion facing the barrier ribs 16.

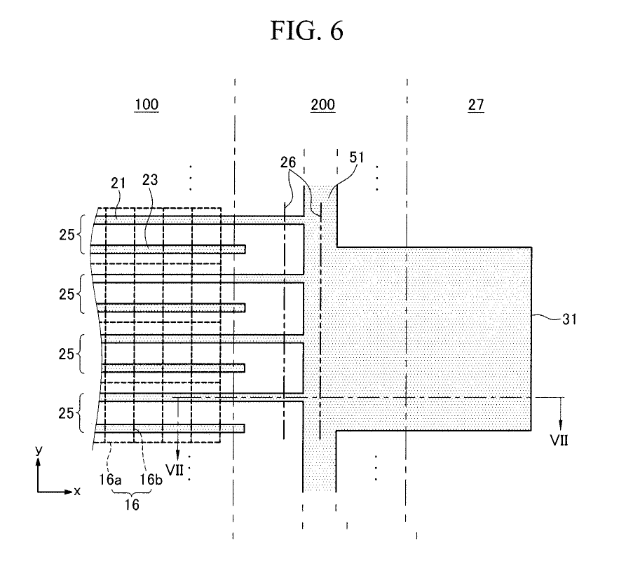

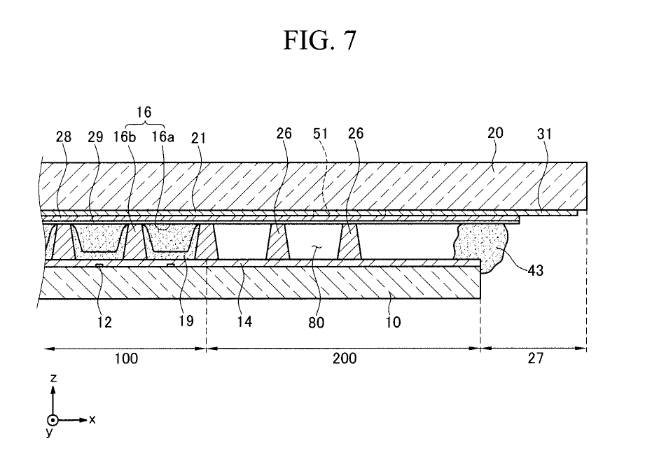

FIG. 6 is a plan view showing an example of forming stripe-type dummy barrier ribs in the non-display area 200. FIG. 7 is a cross-sectional view taken along line VII-VII of FIG. 6.

In FIG. 6, the dummy barrier ribs 26 exist in the non-display area 200. The dummy barrier ribs 26 are spaced apart from the second barrier members 16b, and extend in the y-axis direction in the drawing, parallel to the second barrier members 16b.

Accordingly, as depicted in FIG. 7, channels 80 are formed extending in the y-axis direction in the drawing. In this case, the channels 80 face the connection bar 51.

Therefore, when heat generated from the terminals 31 is conducted to the connection bar 51, because the connection bar 51 faces the channels 80, the heat conducted to the connection bar 51 is transferred to the channels 80, thereby cooling off the terminals 31. In this case, convection occurs along the channels 80 due to a discharge gas, thereby rapidly diffusing heat of the connection bar 51.

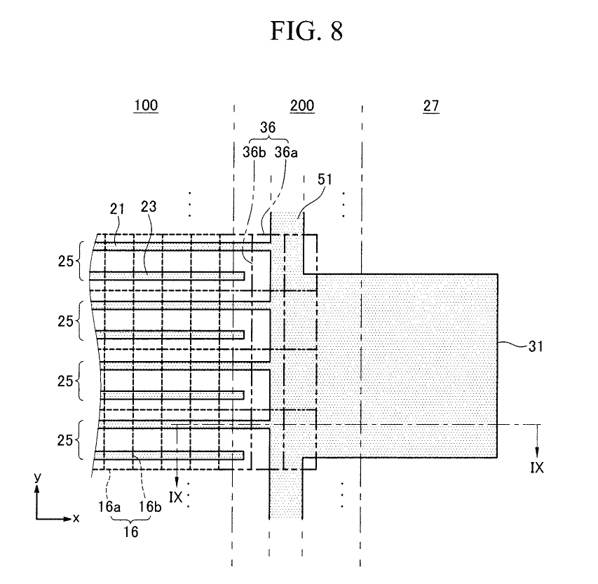

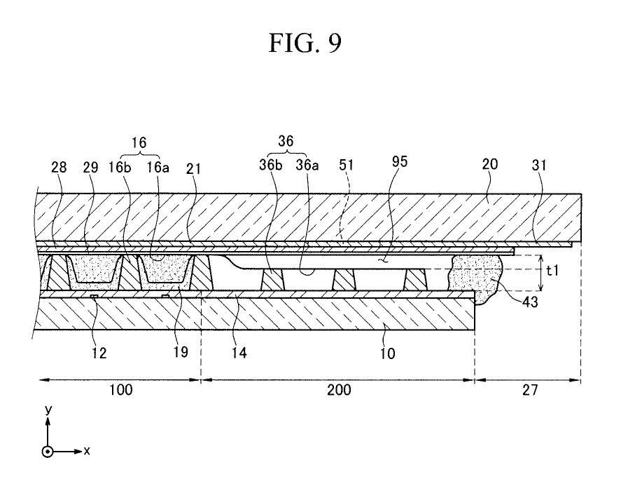

FIG. 8 is a plan view showing an example of forming dummy barrier ribs in the non-display area 200 by using a step difference of the barrier ribs. FIG. 9 is a cross-sectional view taken along line IX-IX of FIG. 8.

Referring to FIG. 8 and FIG. 9, barrier ribs 16 including first barrier members 16a and second barrier members 16b are formed in a display area 100, thereby defining closed-type discharge cells 18.

Dummy barrier ribs 36 including first dummy members 36a and second dummy members 36b are formed in the non-display area 200.

The first dummy members 36a extend from the first barrier members 16a in the x-axis direction in the drawing. The second dummy members 36b extend from the first dummy members 36a in the y-axis direction in the drawing.

In this manner, the dummy barrier ribs 36, including the first and second dummy members 36a and 36b, respectively, extending in the x-axis direction and the y-axis direction in the drawing, define a space of the non-display area 200.

The dummy barrier ribs 36 have a height t1 less than that of the barrier ribs 16. Therefore, even if the dummy barrier ribs 36 are formed in the non-display area 200, an empty space 95 is formed towards the front substrate 20 (see FIG. 9).

Accordingly, when heat generated from the terminals 31 is conducted to the connection bar 51, because the connection bar 51 faces the empty space 95, the heat conducted to the connection bar 51 is transferred to the empty space 95, thereby cooling off the terminals 31.

According to the aforementioned embodiment, a connection bar is formed at terminals of the sustain electrodes, and an empty space is formed in a non-display area in correspondence with the connection bar. Thus, heat generated from the terminals is conducted to the connection bar and is diffused to the empty space, thereby cooling off the terminals and the connection bar.

Although exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A plasma display panel comprising:
a front substrate;
a rear substrate facing the front substrate;
barrier ribs on the rear substrate forming discharge cells in a display area between the front substrate and the rear substrate;
first electrodes and second electrodes on the front substrate facing each other in the discharge cells;
a connection bar connecting end portions of the first electrodes in a non-display area outside the display area; and
terminals extending from the connection bar,
wherein the non-display area includes a heat transfer space.

2. The plasma display panel of claim 1, wherein a dielectric layer covers the first electrodes, the second electrodes, and the connection bar across the display area and the non-display area.

3. The plasma display panel of claim 1, wherein a dielectric layer covers the first electrodes and the second electrodes in the display area only.

4. The plasma display panel of claim 3, wherein the connection bar is exposed to the heat transfer space.

5. The plasma display panel of claim 1, wherein each barrier rib comprises a first barrier member defining a discharge cell in a first direction and a second barrier member defining a discharge cell in a second direction crossing the first direction, the first barrier member and the second barrier member defining a discharge cell.

6. A plasma display panel comprising:
a front substrate;
a rear substrate facing the front substrate;
barrier ribs on the rear substrate forming discharge cells in a display area between the front substrate and the rear substrate;
first electrodes and second electrodes on the front substrate facing each other in the discharge cells;
a connection bar connecting end portions of the first electrodes in a non-display area outside the display area;
terminals extending from the connection bar; and
dummy barrier ribs arranged to form heat transfer channels in the non-display area adjacent the connection bar.

7. The plasma display panel of claim 6, wherein the connection bar is located adjacent the heat transfer channels.

8. The plasma display panel of claim 6, wherein the dummy barrier ribs have the same height as the barrier ribs.

9. The plasma display panel of claim 6, wherein a dielectric layer covers the first electrodes, the second electrodes, and the connection bar across the display area and the non-display area.

10. The plasma display panel of claim 6, wherein a dielectric layer covers the first electrodes and the second electrodes in the display area only.

11. The plasma display panel of claim 10, wherein the connection bar is exposed to the heat transfer channels.

12. The plasma display panel of claim 6, wherein each barrier rib comprises a first barrier member defining a discharge cell in a first direction and a second barrier member defining a discharge cell in a second direction crossing the first direction, the first barrier member and the second barrier member defining a discharge cell.

13. A plasma display panel comprising:
a front substrate;
a rear substrate facing the front substrate;
barrier ribs on the rear substrate forming discharge cells in a display area between the front substrate and the rear substrate;
first electrodes and second electrodes on the front substrate facing each other in the discharge cells;
a connection bar connecting end portions of the first electrodes in a non-display area outside the display area;
terminals extending from the connection bar; and
dummy barrier ribs arranged in the non-display area where the connection bar is located, the dummy barrier ribs having a height less than a height of the barrier ribs such that a heat transfer space is formed between the front substrate and the rear substrate.

14. The plasma display panel of claim 13, wherein a dielectric layer covers the first electrodes, the second electrodes, and the connection bar across the display area and the non-display area.

15. The plasma display panel of claim 13, wherein a dielectric layer covers the first electrodes and the second electrodes in the display area only.

16. The plasma display panel of claim 15, wherein the connection bar is exposed to the heat transfer space.

17. The plasma display panel of claim 13, wherein each barrier rib comprises a first barrier member defining a discharge cell in a first direction and a second barrier member defining a discharge cell in a second direction crossing the first direction, the first barrier member and the second barrier member defining a discharge cell.

18. The plasma display panel of claim 17, wherein each dummy barrier rib comprises a first dummy member defining the heat transfer space in the first direction and a second dummy member defining the heat transfer space in the second direction.
